(19) United States
(12) Patent Application Publication
(10) Pub. No.: US 2022/0346481 A1
(43) Pub. Date: Nov. 3, 2022

(54) HEAD MOLD FOR MAKING WIG, AND METHOD FOR MANUFACTURING SAME

(71) Applicant: Seowoo Digital Co., Ltd., Seoul (KR)

(72) Inventor: Hakyoung LEE, Seoul (KR)

(73) Assignee: Seowoo Digital Co., Ltd., Seoul (KR)

(21) Appl. No.: 17/762,896

(22) PCT Filed: Sep. 28, 2020
(86) PCT No.: PCT/KR2020/013211

§ 371 Date: Mar. 23, 2022

(30) Foreign Application Priority Data
Sep. 30, 2019 (KR) 10-2019-0120949

(51) Int. Cl. A41G 3/00; B33Y 80/00; B33Y 40/20; B29C 59/02

(52) U.S. Cl. CPC A41G 3/0075; B33Y 80/00; B33Y 40/20; B29C 59/02; B29L 2031/4807

(57) ABSTRACT

A head mold for a wig may include a head mold body and an information pattern. The head mold body may be formed using a stack type three-dimensional (3D) printer into which head information of a user may be inputted. The information pattern may be provided to the head mold body to indicate information of the wig. The head mold may be manufactured using the stack type 3D printer to prevent a generation of dusts during manufacturing the head mold. Further, the stack type 3D printer may have a low price compared to a milling machine to reduce an initial investment cost for manufacturing the head mold.

CROS S-RELATED APPLICATION

This application claims priority under 35 U.S.C. § 119 to Korean Patent Application No. 2019-0120949, filed on Sep. 30, 2019 in the Korean Intellectual Property Office (KIPO), the contents of which are herein incorporated by reference in their entirety.

### BACKGROUND

### 1. Field

Example embodiments relate to a head mold for a wig and a method of manufacturing the same. More particularly, example embodiments relate to a head mold including information of a user's head for manufacturing a wig and a method of manufacturing the head mold.

### 2. Description of the Related Art

Generally, a wig may be manufactured by measuring a shape of a user's head using a three-dimensional head scanner to obtain data of the head, sketching a wig pattern coincided with the user on a head mold, manufacturing the head mold using the data, implanting hairs into a skin using the head mold, etc.

According to related arts, the head mold may be manufactured by machining a urethane mold using a milling machine. During the milling process, urethane dusts generated from the mold may damage a worker's health. Further, because the milling machine may be too expensive, an initial investment cost of the head mold may be so high.

### SUMMARY

Example embodiments provide a head mold for a wig that may be capable of preventing a generation of dust damaging a worker's health and being manufactured by a low cost.

Example embodiments also provide a method of manufacturing the above-mentioned head mold.

According to example embodiments, there may be provided a head mold for a wig. The head mold may include a head mold body and an information pattern. The head mold body may be formed using a stack type three-dimensional (3D) printer into which head information of a user may be inputted. The information pattern may be provided to the head mold body to indicate information of the wig.

In example embodiments, the information pattern may be embossed on a surface of the head mold body.

In example embodiments, the information pattern may be engraved on a surface of the head mold body. The head mold may further include a material configured to fill the engraved information pattern. The material may have a surface substantially coplanar with the surface of the head mold body.

In example embodiments, the information pattern may be formed on a surface of the head mold body using the stack type 3D printer.

According to example embodiments, there may be provided a method of manufacturing a head mold for a wig. In the method of manufacturing the head mold for the wig, head information of a user may be inputted into a stack type three-dimensional (3D) printer. A head mold body may be formed using the 3D printer. An information pattern having information of the wig may be formed at the head mold body.

In example embodiments, forming the information pattern at the head mold body may include embossing on a surface of the head mold body.

In example embodiments, forming the information pattern at the head mold body may include engraving on a surface of the head mold body. The method may further include filling the engraved information pattern with a material.

In example embodiments, forming the information pattern at the head mold body may include forming the head information on a surface of the head mold body using the stack type 3D printer.

According to example embodiments, the head mold may be manufactured using the stack type 3D printer to prevent a generation of dusts during manufacturing the head mold. Further, the stack type 3D printer may have a low price compared to a milling machine to reduce an initial investment cost for manufacturing the head mold.

### BRIEF DESCRIPTION OF THE DRAWINGS

Example embodiments will be more clearly understood from the following detailed description taken in conjunction with the accompanying drawings. FIGS. 1 to 8 represent non-limiting, example embodiments as described herein.

FIG. 1 is a perspective view illustrating a head mold for a wig in accordance with example embodiments;

FIG. 2 is an enlarged perspective view of a portion “II” in FIG. 1;

FIG. 3 is a cross-sectional view taken along a line III-III′ in FIG. 2;

FIG. 4 is a flow chart illustrating a method of manufacturing the head mold in FIG. 1;

FIG. 5 is a perspective view illustrating a head mold for a wig in accordance with example embodiments;

FIG. 6 is an enlarged perspective view of a portion “VI” in FIG. 5;

FIG. 7 is a cross-sectional view taken along a line VII-VII′ in FIG. 6; and

FIG. 8 is a flow chart illustrating a method of manufacturing the head mold in FIG. 5.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

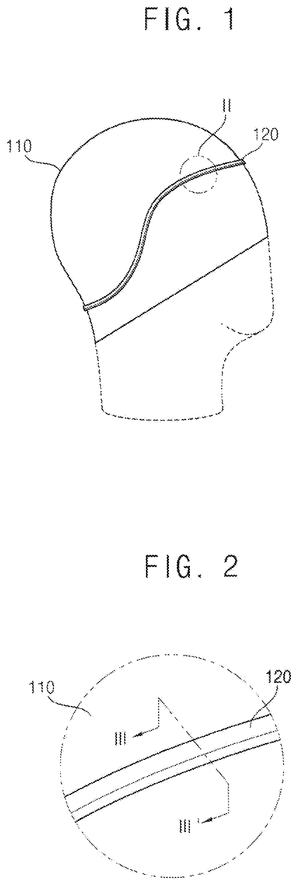

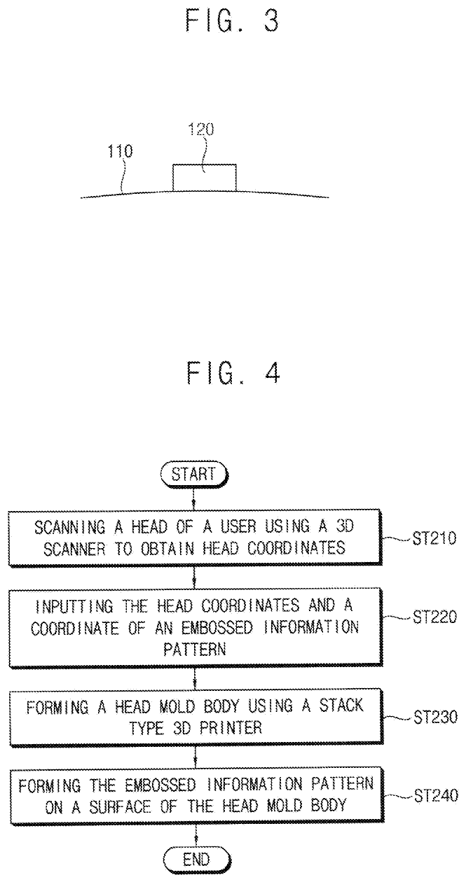

FIG. 1 is a perspective view illustrating a head mold for a wig in accordance with example embodiments, FIG. 2 is an enlarged perspective view of a portion “II” in FIG. 1 and FIG. 3 is a cross-sectional view taken along a line III-III′ in FIG. 2.

Referring to FIGS. 1 to 3, a head mold for a wig in accordance with example embodiments may include a head mold body 110 and an information pattern 120. In FIG. 1, the head mold, which may be actually manufactured, may correspond to an upper structure indicated by a solid line. A lower structure indicated by a dotted line may be used for an understanding of the head mold.

The head mold body 110 may have a shape substantially the same as a head shape of a user. In example embodiments, the head mold body 110 may be formed using a stack type three-dimensional (3D) printer.

Particularly, the head of the user may be scanned using a 3D scanner to obtain head coordinates of the user. The head coordinates of the user may be inputted into the stack type 3D printer. The stack type 3D printer may form the head mold body 110 along the head coordinates using a printing material. The printing material may include a plastic powder, not limited thereto.

Thus, because the head mold body 110 may be formed by stacking the printing material of the stack type 3D printer, dust may not be generated during forming the head mold body 110. As a result, factors damaging a worker such as the dust may be removed.

The information pattern 120 may be formed on a surface of the head mold body 110. The information pattern 120 may include information of the wig. For example, the information pattern 120 may include a part direction of the wig, a hair kind of the wig, a tape borderline for attaching the wig, etc. In example embodiments, the information pattern 120 may include the tape borderline. Thus, the information pattern 120 may have a long linear shape extending along ends of the wig.

In example embodiments, the information pattern 120 may have an embossed structure. The embossed information pattern 120 may protrude from the surface of the head mold body 110. The worker may attach a tape on the head mold body 110 along the embossed information pattern 120. The embossed information pattern 120 may have various shapes such as a circular shape, a triangular shape, a quadrangular shape, etc.

Further, the embossed information pattern 120 may be integrally formed with the head mold body 110. That is, the embossed information pattern 120 may be formed simultaneously with forming the head mold body 110 using the stack type 3D printer. Thus, a coordinate of the embossed information pattern 120 may also be inputted into the stack type 3D printer. The embossed information pattern 120 may include a material substantially the same as a material of the head mold body 110. Alternatively, the material of the embossed information pattern 120 may be different from the material of the head mold body 110.

FIG. 4 is a flow chart illustrating a method of manufacturing the head mold in FIG. 1.

Referring to FIGS. 1 and 4, in step ST210, the head of the user may be scanned using the 3D scanner to obtain the head coordinates of the user.

In step ST220, the head coordinates of the user may be inputted into the stack type 3D printer. Further, the coordinate of the embossed information pattern 120 may be inputted into the stack type 3D printer.

In step ST230, the stack type 3D printer may form the head mold body 110 using the printing material along the head coordinates.

In step ST240, the stack type 3D printer may form the embossed information pattern 120 on the surface of the head mold body 110.

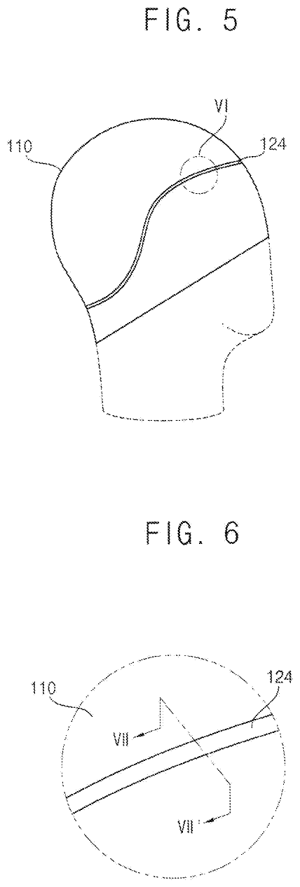

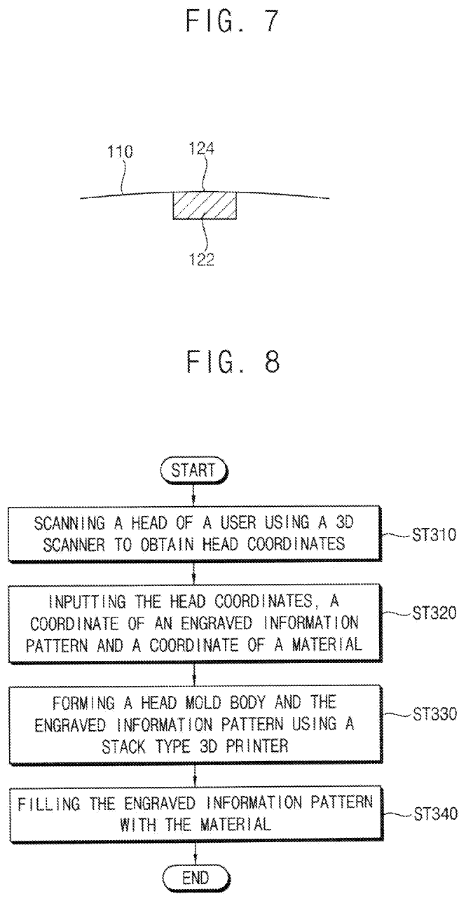

FIG. 5 is a perspective view illustrating a head mold for a wig in accordance with example embodiments, FIG. 6 is an enlarged perspective view of a portion “VI” in FIG. 5 and FIG. 7 is a cross-sectional view taken along a line VII-VII' in FIG. 6.

The head mold of this example embodiment may have a shape substantially the same as the shape of the head mold in FIG. 1 except for a shape of an information pattern. Thus, the same reference numerals may refer to the same elements and any further illustrations with respect to the same elements may be omitted herein for brevity.

Referring to FIGS. 5 to 7, an information pattern 122 of example embodiments may have an engraved structure. That is, the information pattern 122 may correspond to a groove formed by engraving the surface of the head mold body 110. Further, the engraved information pattern 122 may be filled with a material 124. The material 124 may have a surface substantially coplanar with the surface of the head mold body 110. Alternatively, the surface of the material 124 may be higher or lower than the surface of the head mold body 110.

The engraved information pattern 122 may be formed simultaneously with forming the head mold body 110 using the stack type 3D printer. Thus, a coordinate of the engraved information pattern 122 may also be inputted into the stack type 3D printer.

The material 124 may be formed in the engraved information pattern 122 using the stack type 3D printer. A coordinate of the material 124 may be inputted into the stack type 3D printer. The material 124 may be substantially the same as the material of the head mold body 110. Alternatively, the material 124 may be different from the material of the head mold body 110.

FIG. 8 is a flow chart illustrating a method of manufacturing the head mold in FIG. 5.

Referring to FIGS. 5 and 8, in step ST310, the head of the user may be scanned using the 3D scanner to obtain the head coordinates of the user.

In step ST320, the head coordinates of the user may be inputted into the stack type 3D printer. Further, the coordinate of the engraved information pattern 122 may be inputted into the stack type 3D printer. The coordinate of the material 124 may also be inputted into the stack type 3D printer.

In step ST330, the stack type 3D printer may form the head mold body 110 and the engraved information pattern 122 using the printing material along the head coordinates and the coordinate of the engraved information pattern 122.

In step ST340, the stack type 3D printer may form the material in the engraved information pattern 122.

Additionally, data of a plurality of the head molds in accordance with the heads of the users may be managed using a cloud server. For example, the data may be transmitted between the cloud server, an individual server a smart phone, a laptop, a tablet, a desktop, etc. Thus, a burden of a data processing in wig fabrication factories may be reduced. Further, the cloud server may provide an upgraded program so that a continuous server may also be provided. Furthermore, an artificial intelligence (AI) may be introduced by accumulating the data in the cloud server.

According to example embodiments, According to example embodiments, the head mold may be manufactured using the stack type 3D printer to prevent a generation of dusts during manufacturing the head mold. Further, the stack type 3D printer may have a low price compared to a milling machine to reduce an initial investment cost for manufacturing the head mold.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A head mold for a wig, the head mold comprising:
a head mold body formed using a stack type three-dimensional (3D) printer into which head information of a user is inputted; and
an information pattern provided to the head mold body to indicate information of the wig.

2. The head mold of claim 1, wherein the information pattern is embossed on a surface of the head mold body.

3. The head mold of claim 1, wherein the information pattern is engraved on a surface of the head mold body.

4. The head mold of claim 3, further comprising a material configured to fill the engraved information pattern.

5. The head mold of claim 4, wherein the material has a surface substantially coplanar with the surface of the head mold body.

6. The head mold of claim 1, wherein the information pattern is formed on a surface of the head mold body using the stack type 3D printer.

7. A method of manufacturing a head mold for a wig, the method comprising:
inputting head information of a user into a stack type 3D printer;
forming a head mold body using the stack type 3D printer; and
forming an information pattern at the head mold body to indicate information of the wig.

8. The method of claim 7, wherein forming the information pattern at the head mold body comprises embossing the information pattern on a surface of the head mold body.

9. The method of claim 7, wherein forming the information pattern at the head mold body comprises engraving the information pattern on a surface of the head mold body.

10. The method of claim 9, further comprising filling the engraved information pattern with a material.

11. The method of claim 7, wherein forming the information pattern at the head mold body comprises forming the information pattern on a surface of the head mold body using the stack type 3D printer.
